(19) United States
(12) Patent Application Publication
(10) Pub. No.: US 2017/0132634 A1
(43) Pub. Date: May 11, 2017

(54) Method and System for Generating Random Postal Codes Attached to a Credit or Debit Card to Help Prevent Fraud

(71) Applicant: Jason James, Middleburg, FL (US)

(72) Inventor: Jason James, Middleburg, FL (US)

(21) Appl. No.: 14/937,849

(22) Filed: Nov. 10, 2015

(51) Int. Cl. G06Q 20/40; G06Q 20/38

(52) U.S. Cl. CPC G06Q 20/4016; G06Q 20/4012; G06Q 20/3829

(57) ABSTRACT

A method and system to generate a random and alternating postal code attached both to the financial institution and the credit or debit card issued to the account holder. The postal code is generated with an algorithm based random number generator (RNG) or a pseudo random number generator (PRNG) as an added security feature. The authorized card holder is in possession of a device that would provide the card holder the correct randomized postal code.

### CROSS-REFERENCE TO RELATED APPLICATION

The present application is related to and claims priority from prior provisional application Ser. No. 62/069,816, filed Oct. 28, 2014 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

At least some embodiments disclosed herein relate, in general, to systems and methods for preventing credit and debit card fraud and more specifically for systems and methods for preventing credit and debit card fraud by generating random codes attached to credit and debit cards, for example, random postal codes used for address verification.

### BACKGROUND

Credit card and debit card fraud is becoming a larger problem growing every day around the world. According to a study by the Federal trade commission the United States accounts for over 40% of total credit card fraud around the world and over 20% of the world's debit card fraud, with many victims reporting the fraud on more than one occurrence.

According to the United States department of justice, research released in 2013 showed an estimated 16.6 million persons ages 16 or older were victims of identity theft. The majority of these incident's involved the fraudulent use of existing account information. About 36% of victims reported moderate or severe emotional distress as a result of the incident.

According to the Nilson Report august 2013 Direct or indirect loses from credit card and debit card fraud totaled $7.6 billion in 2010, $9.8 billion in 2011 and $11.2 billion in 2012. In 2012 card issuers incurred over 63% of total losses. These losses occur mainly at the point of sale where the card issuer is responsible for the loss if authorization is given to accept the payment.

Currently many financial institutions use a system called AVS (Address Verification System) which at the time of purchase checks the users address and postal code on file to verify the purchasers identity, the current issue is that most credit and debit card fraud is caused by a breech in data or stolen identity information, after the data is stolen the thief is able to bypass current security checks and is often able to use the cards information multiple times before the activity can be identified and stopped. In today's industry unfortunately this is occurring more and more every day as cyber fraud is becoming a larger threat.

At this time many online, electronic commerce and face-to-face credit card purchases are verified at the time of purchase by using the AVS system, which with the current system checks are easily passed if the card holder's information was stolen. In many retail locations a customer is more likely to shop near their residence for convenience, therefore a thief could simply use the postal code in the same location that the card or information is stolen.

### SUMMARY

The present disclosure relates to a method and system to generate a random and alternating postal code attached both to the financial institution and the credit or debit card issued to the account holder. The postal code could be generated with an algorithm based random number generator (RNG) or a pseudo random number generator (PRNG) as an added security feature.

In embodiments in accordance with the present disclosure, the authorized card holder is in possession of a device that would provide the card holder the correct randomized postal code, for example, an application used on current mobile operating software for cell phones, smart phones, smart watches, tablets and/or a portable device such as a key fob with a display screen or a Near Field Communication (NFC) device. Such randomized postal code could then be used at the time of the card's use. Where a stolen credit or debit card is verified at a time of purchase, on the other hand, the card thief would be very unlikely to be able to provide a correct postal code

### BRIEF DESCRIPTION OF THE DRAWINGS

The embodiments are illustrated by way of example and not limitation in the figures of the accompanying drawings in which like references indicate similar elements.

FIG. 1 Shows a simplified chart to demonstrate the process of verification from start to finish.

FIG. 2 Is a logical flowchart of the display and use of the postal code.

FIG. 3 Illustrates a process of linking both the display devices and the credit card or debit card for use.

FIG. 4 illustrates an embodiment of a specialized Near Field Communication device that could be used to implement the systems and methods of the present disclosure.

FIG. 5 illustrates an embodiment of a specialized Near Field Communication device that could be used to implement the systems and methods of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure relates to a method and system to generate a random and alternating postal code attached both to the financial institution and the credit or debit card issued to the account holder. The postal code could be used with an algorithm based random number generator (RNG) or a pseudo random number generator (PRNG) as an added security feature.

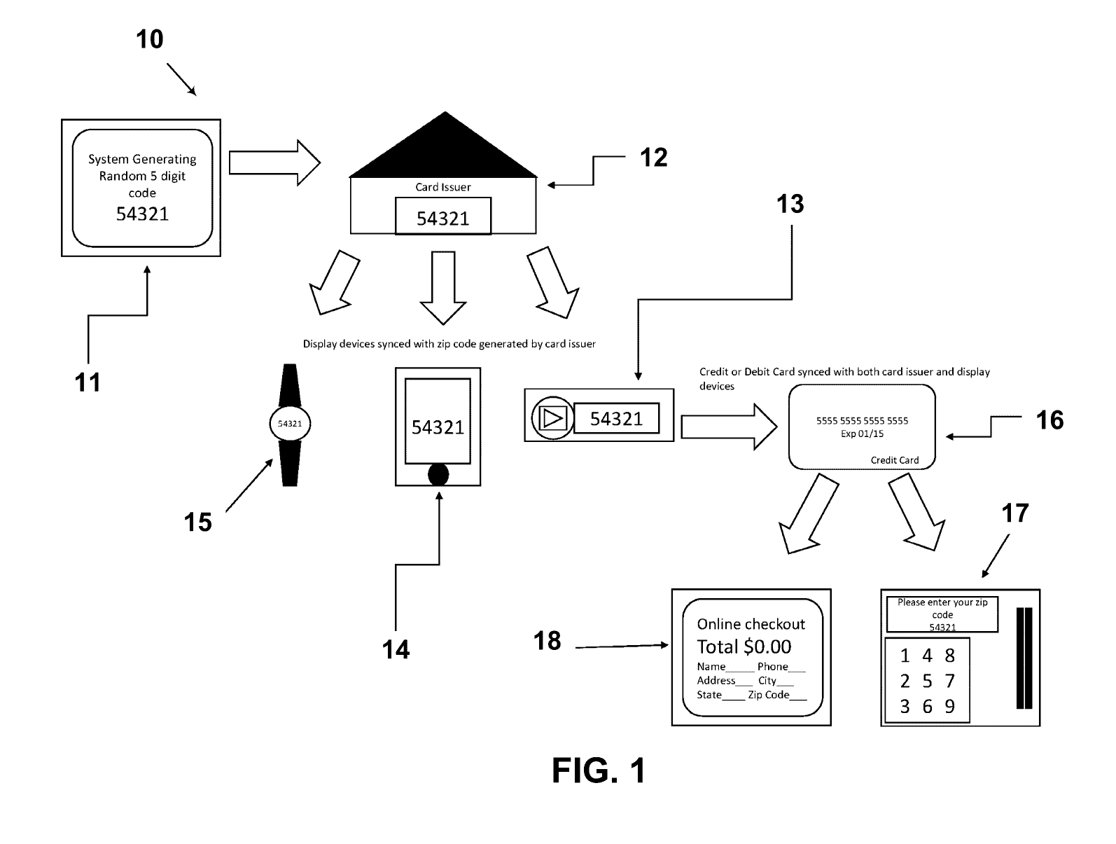

FIG. 1 provides an overview of at least one embodiment 10 of the present disclosure.

The system 11 generates a random 5 to 9 digit code in a timed synchronized method. In an embodiment, the system is implemented on a card issuer's 12 server. In an embodiment, the system is implemented as a third-party service linked to the card issuer 12. In an embodiment, is generated using an algorithm based random number generator (RNG) or a pseudo random number generator (PRNG) as an added security feature. In an embodiment, the card issuer's 12 systems then associate the random code with a user's debit or credit card 16 such that the random code is to be used for purchases.

In an embodiment, the random code is synchronized with user devices, such as cell phones 14, Smart watches 15, tablets 14 and/or a portable device such as a key fob 13 with a display screen. In an embodiment, the random code is synchronized with user devices by transmitting the code to the user's device 13, 14, or 15 on demand, via, for example, a cellular network, a wireless network or the Internet. In an embodiment, the random code is synchronized on user devices 13, 14 or 15 by implementing the same time sequenced method for generating random codes as an application on user devices.

In an embodiment, each display device 13, 14 and 15 is provided a unique serial number that is linked to the credit card or debit card in the financial institutions system. After the card and display devices are synced the software would then begin to generate the random number algorithm as a 5-9 digit postal code in a pre-determined time frame designated by the financial institution or card issuer. Such random codes would then be used to make purchases, for example, for example, at a numeric credit card terminal or point of sale terminal 17 or for an online purchase through a retailers website or online commerce website 18.

In other embodiment, the random code could be less than 5 or more than 9 digits.

Thus, with the implementation of a system that randomly changes the postal code associated with a credit or debit card many fraudulent transactions could be stopped at the time of final processing if the postal code does not match the current code being displayed to the card holder. The financial institution would still maintain the cardholder's real postal code on file and this system could be linked solely to the card for approval purposes.

In an embodiment, a financial institution could also apply this method for use with debit card transactions as a rotating PIN (Personal Identification Number) to also reduce the chance of fraudulent activity due to a stolen PIN number.

In an embodiment, a user could be provided with an emergency one time postal code or 5-9 digit PIN in the case of user losing access to the display device. After the emergency code is used the issuing institution could then deactivate the code after a specified time frame then issue a new code for future use if necessary.

Those skilled in the art will appreciate that a similar system could also be implemented in other countries such as Europe, Asia and the Middle East where many financial institutions use the EMV chip which requires a 4-6 digit PIN to process a face-to-face transaction at the point of sale. The combination of the random postal code with the EMV systems would help to prevent CNP (Card Not Present) fraud dramatically. Many card issuing providers are also preparing to utilize EMV systems in the United States by October 2015.

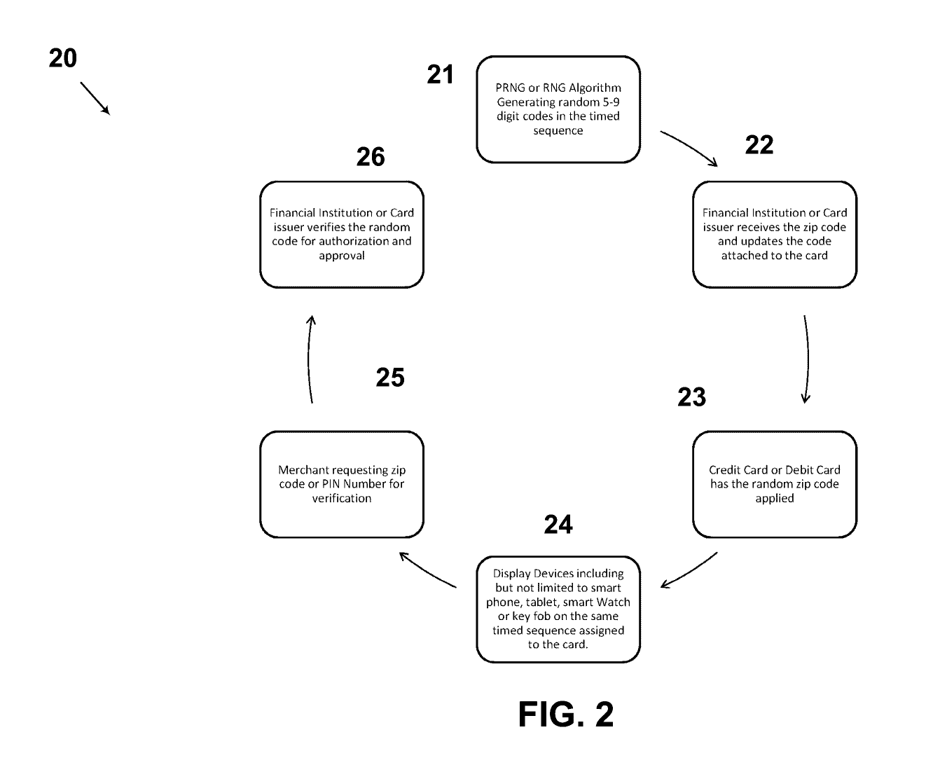

FIG. 2 is a chart to further illustrate an embodiment the method and process 20 of the flow for the generation of the 5 to 9 digit code being sent or updated in the financial institution or card holders system.

In an embodiment, a random 5-9 code is generated by a system 21. In an embodiment, the random code is generated by an algorithm based random number generator (RNG) or a pseudo random number generator (PRNG). In an embodiment, the random code is generated in a timed sequence specified by a card issuer. In an embodiment, the random number generator is implemented using software on the user device. In an embodiment, the random number generator is implemented as firmware or hardware on the user device.

In an embodiment, the random code is uploaded to a card issuer's system 22, for example, via a cellular, wireless or Internet connection. The card issuer's system then updates the random code associated with the card thereby updating the information synced to the credit card or debit card being used 23

In an embodiment, user display devices such as smart phones, smart watches, tablets or key fobs are on the same timed sequence as assigned to the card by the card issuer 24. When a merchant requests a zip code to finalize a purchase 25, the user accesses the current random code for their card by accessing the appropriate application or function on their display device, which displays the same code that is being updated with both the card and card issuer. The user then enters or gives the current code to the merchant for verification. The card issuer then verifies the random code for authorization and approval 26.

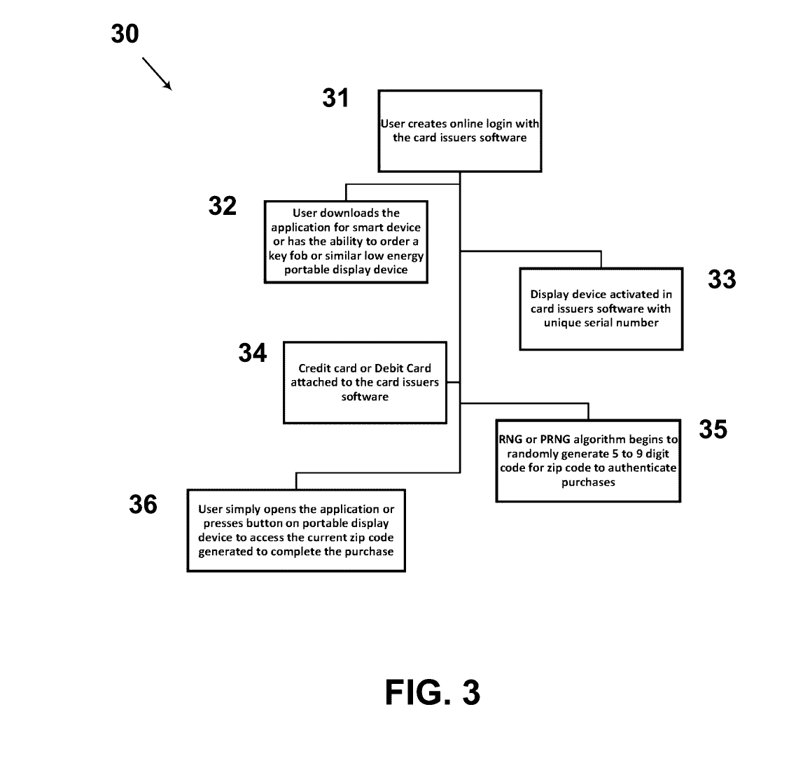

FIG. 3 is a diagram showing the process of how a user could activate and sync the credit card or debit card with his or her financial institution or card issuer.

In an embodiment, a user having a card with a card issuer creates an online login using the card issuer's software 31, In an embodiment, the user elects to participate in a random code verification program. In an embodiment, the user is automatically assigned to a random code verification program.

In an embodiment, the user then downloads a random code display application to a user device 32, for example, to a smart phone, smart watch, or tablet computer. Alternatively, the user may obtain a single purpose device such as a key fob or other low-power device configured to generate random codes.

In an embodiment, once the user has obtained a display device or downloaded the display application to a smart device, the user then activates the time synchronized pseudo random code with a unique serial number provided with each device or application download 33.

In an embodiment, the user's card is then attached to the card issuer's software 34. In an embodiment, the card is automatically attached when the user activates the random code software. In an embodiment, the user explicitly requests, for example, via the card issuer's software, the card to be attached to the card issuer's software.

In an embodiment, the system then begins to generate 5-9 digit random codes using RNG or PRNG algorithms that can be used for zip authentication of purchases 35. In an embodiment, when a user wishes, or is required, to authenticate a purchase using a random code, the user opens the random code application on the user's registered device which displays the currently applicable random code 36.

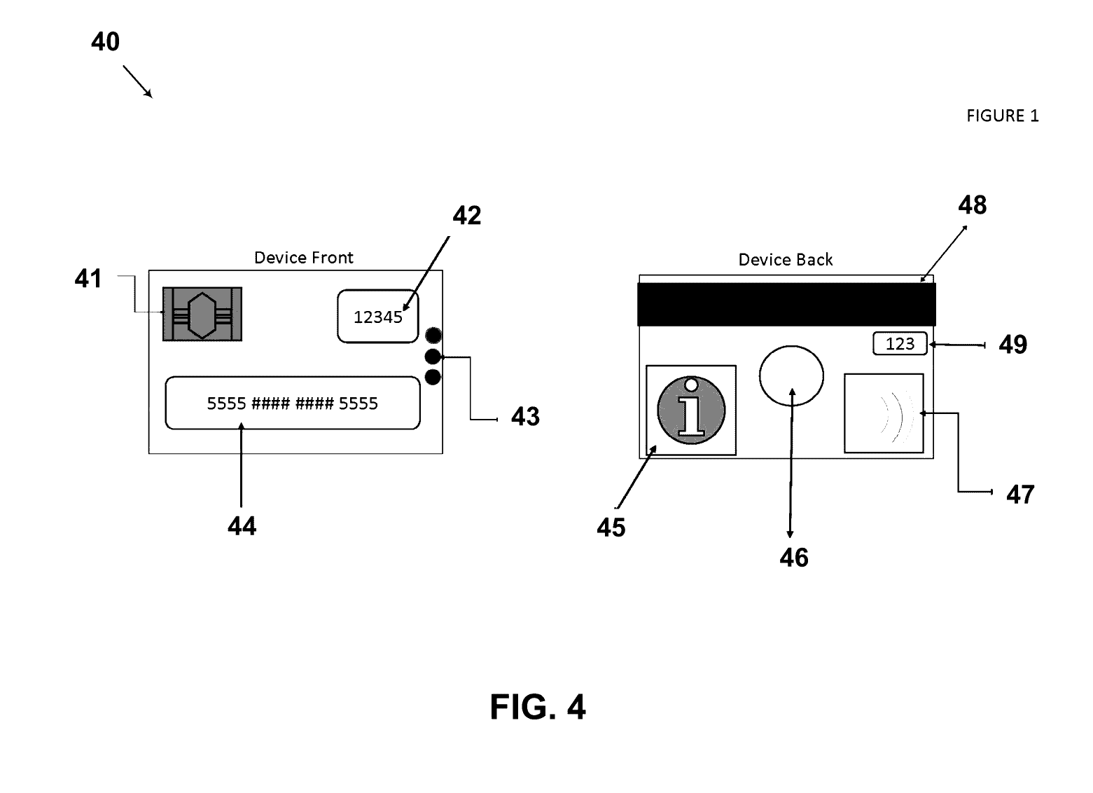

FIG. 4 illustrates an embodiment of a specialized Near Field Communication device 40 that could be used to implement the systems and methods of the present disclosure.

In an embodiment, the device is able to receive and process transactions utilizing a Near Field Communication wallets linked credit or debit card account information without retaining or displaying sensitive account information during transactions processed online or at terminals unable to process a contactless payment due to non-equipped POS terminals or POS terminals with the NFC ability turned off or disabled.

In an embodiment, the device implements the capability to generate, display and transmit via NFC the randomized zip code or PIN of the present disclosure associated with the account for approval processes such as Address Verification and the one time token generated account number processed by the NFC wallet with a LCD screen or similar display device while also possessing a programmable EMV chip and magnetic stripe to process the transactions generated by the NFC wallet.

The device could be linked to the Smart NFC wallet handling the transactions as a trusted device to also prevent unauthorized use from other devices. Once the display device is linked it would then be able to process the transaction and receive information selected from the NFC wallet for a short designated amount of time to also reduce the possibility of fraudulent activity with the display device if lost or stolen.

The device 40 Illustrated in FIG. 4 includes a programmable EMV 41 for use with Chip and PIN terminals. The device additionally comprises an LCD screen 42. In an embodiment, the LCD screen 42 can be used to displaying a 1 use random PIN number or zip code. The device 40 additionally comprises a power indicator and ready indicator 43. The device 40 additionally comprises a second LCD screen 44 displaying a random generated token utilized for the 1-time online payment account number. The screen 44 could also be used to display the 5-9 random zip code of the present disclosure.

Turning to the back of the device 40, the device additionally comprises a short term memory 45 for receiving NFC created information. The device 40 additionally comprises a power supply 46. The device additionally comprises a receiving Near Field Communication chip 47. The device 40 additionally comprises a programmable magnetic stripe 48 for use on older POS terminals. The device 40 additionally comprises an LCD screen 49 to display a random CCV 3 digit code.

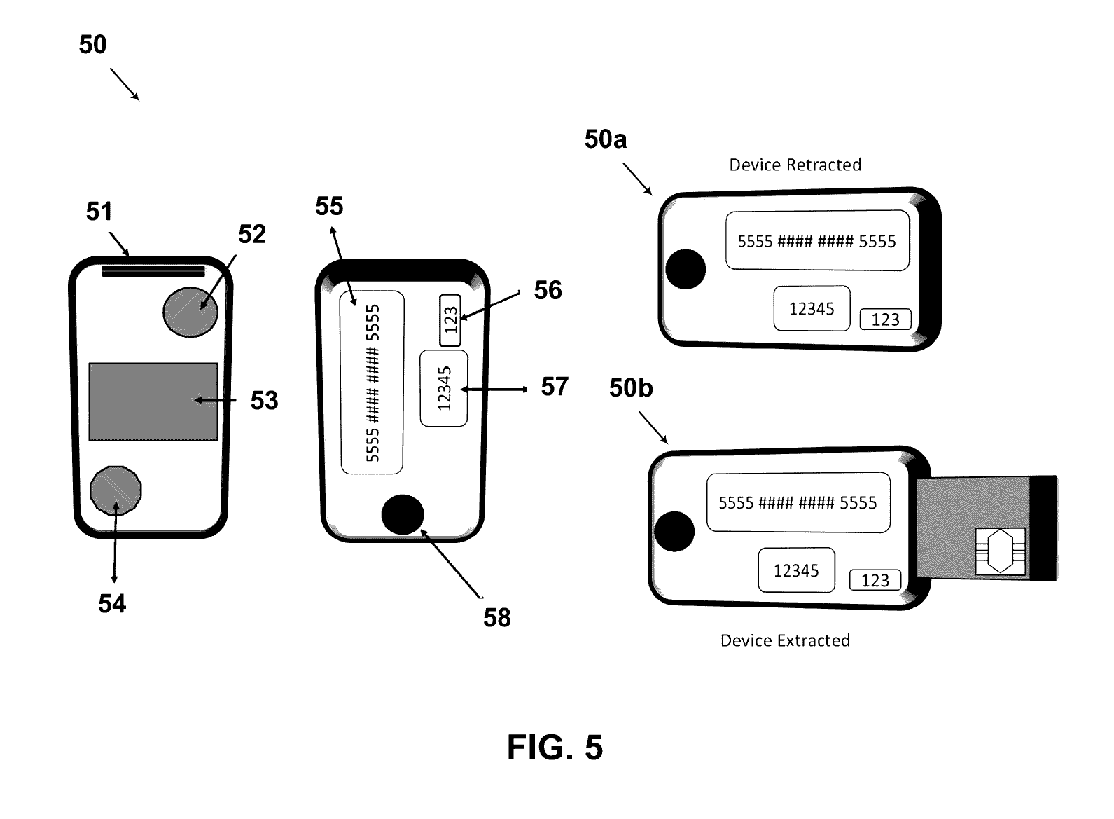

FIG. 5 illustrates another embodiment of a specialized Near Field Communication device 50 that could be used to implement the systems and methods of the present disclosure.

The design shown in FIG. 5 has a retractable programmable magnetic stripe and Chip and PIN. The device 50 is shown in a retracted state in 50a, and an extracted state in 50b.

Referring to the back of the device, the device 50 comprises a port 51 for the retractable magnetic stripe and Chip and PIN. The device additionally comprises a power source 52. The device 50 additionally comprises a memory device 53. The device 50 additionally comprises a Near Field Communication or Bluetooth® receivable chip 54.

Turning to the front of the device 50, the device additionally comprises an LCD screen 55 shown displaying a randomized account number. The screen 55 could also be used to display the 5-9 random zip code of the present disclosure. The device 50 additionally comprises a second LCD screen 56 for displaying a randomized CCV 3 digit security code. The device additionally comprises an LCD screen 57 for displaying a randomized personal identification number or zip code for address verification. The device additionally comprises a power or activation key 58.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A method comprising:
generating, using a computing device, a random code associated with a user card issued by a card issuer;
providing, via a network, the random code to the card issuer whereby the card issuer is caused to associate the random code with the user card as a verification code for transactions;
generating, responsive to a request from the user on a user device, the random code whereby the user is caused to utilize the random code to verify a transaction relating to the user card.

2. The method of claim 1 wherein random code is generated using an algorithm comprising one of: a random number generation algorithm and a pseudo random number generation.

3. The method of claim 2 wherein the algorithm is one of a key based algorithm and a time based algorithm.

4. The method of claim 3 wherein the random code between 5 and 9 digits.

5. The method of claim 4 wherein the random code is a random zip code whereby the card issuer is caused to associate the random code with the user card as an address verification code for purchase transactions.

6. The method of claim 4 wherein the random code is a random PIN code whereby the card issuer is caused to associate the random code with the user card as a PIN code for one of ATM transactions and face-to-face transactions.

7. The method of claim 1 wherein the user device is a smart device, wherein the user device is provided a mobile application that causes the device to display the random code to the user responsive to the user request.

8. The method of claim 7 wherein the user device one of: a smart phone, a smart watch and a tablet.

9. The method of claim 1 wherein the user device is a low-power device that is programmed to display the random code to the user responsive to the user request.

10. The method of claim 9 wherein the user device one of: a key fob and a NFC device.

11. The method of claim 1 wherein the user device is associated with a unique serial number that is linked to the card on a card provider system.

12. The method of claim 1 wherein the user provided with an emergency one time use random code in the event the user loses the user device.

13. A system comprising:
a computing device configured to
generate a random code associated with a user card issued by a card issuer;
provide the random code to the card issuer whereby the card issuer is caused to associate the random code with the user card as a verification code for transactions;
a user device configured to
generate, responsive to a request from the user, the random code whereby the user is caused to utilize the random code to verify a transaction relating to the user card.

14. The system of claim 13 wherein random code is generated using an algorithm comprising one of: a random number generation algorithm and a pseudo random number generation.

15. The system of claim 14 wherein the algorithm is one of a key based algorithm and a time based algorithm.

16. The system of claim 15 wherein the random code is a random zip code whereby the card issuer is caused to associate the random code with the user card as an address verification code for purchase transactions.

17. The system of claim 15 wherein the random code is a random PIN code whereby the card issuer is caused to associate the random code with the user card as a PIN code for one of ATM transactions and face-to-face transactions.

18. The system of claim 13 wherein the user device is a smart device, wherein the user device is provided a mobile application that causes the device to display the random code to the user responsive to the user request.

19. The system of claim 18 wherein the user device one of: a smart phone, a smart watch and a tablet.

20. The system of claim 13 wherein the user device is a low-power device that is programmed to display the random code to the user responsive to the user request.
